(19) United States
(12) Patent Application Publication
(10) Pub. No.: US 2002/0116180 A1
(43) Pub. Date: Aug. 22, 2002

(54) Method for transmission and storage of speech

(76) Inventor: Zinovy D. Grinblat, Medford, MA (US)

Correspondence Address: ZINOVY D. GRINBLAT, 8 NINTH STREET #616, MEDFORD, MA, 02155, US

(21) Appl. No.: 09/788,094

(22) Filed: Feb. 20, 2001

(51) Int. Cl. G10L 21/00; G10L 19/00

(52) U.S. Cl. 704/201

(57) ABSTRACT

The present invention provides a new method for the transmission and storage of speech by transmission of a personal speech codebook and indices of the spoken speech of the speaker, comprising of the following steps: a) creating the personal speech codebook of the speaker in advance; b) permanently storing the personal speech codebook of the speaker; c) transmitting the personal speech codebook of the speaker; d) receiving the personal speech codebook of the speaker; e) storing temporally the received personal speech codebook of the speaker, f) dynamically updating the personal speech codebook of the speaker, g) transmitting indices of the spoken speech of the speaker, h) receiving indices of the spoken speech of the speaker, i) decoding transmitted indices of the spoken speech of the speaker to the original spoken speech. The same personal speech codebook of the speaker can use for verification, identification and recognition.

### BACKGROUND OF THE INVENTION

The present invention relates to the low-bit-rate transmission and storage of speech by using a Vector Quantization (VQ) technique. In the vector quantization technique, an encoder and a decoder have an identical codebook vectors. Some codebooks contain sets of vector coefficients (Twin VQ algorithm) [3]. Other codebooks contain phonemes, words and phrases. One of the disadvantages of using codebooks is a long duration of coding time. “ . . . The larger we make the codebook (so as to reduce quantization error) the more storage is required for the codebook entries . . . There is so much variability in the spectral properties of each of the basic speech units, including ranges in age, accent, speaking rate of speech units including specific recognition vocabularies (e.g. digits) and conversational speech.” [1] Another disadvantage of using current codebooks is its automatic speaker identification performance. If the user population of automatic speaker identification system is large, more complex models are needed to improve identification accuracy. If the user population of automatic speaker identification system becomes very large, then a “ . . . reliable speaker identification essentially becomes impossible.” [1]

### SUMMARY OF THE INVENTION

The present invention provides a new method for the low-bit-rate transmission and storage of speech, which overcomes the defects in the prior art and is capable of greatly reducing quantization error and of reducing the storage space for the codebook entries.

Furthermore, the present invention provides a new method for the low-bit-rate transmission and storage of speech by transmission of a personal speech codebook and indices of the spoken speech of the speaker, comprising of the following steps: a) creating the personal speech codebook of the speaker in advance; b) permanently storing the personal speech codebook of the speaker; c) transmitting the personal speech codebook of the speaker; d) storing temporally the received personal speech codebook of the speaker; e) dynamically updating the personal speech codebook of the speaker; f) receiving the personal speech codebook of the speaker; g) transmitting indices of the spoken speech of the speaker, h) receiving indices of the spoken speech of the speaker, i) decoding transmitted indices of the spoken speech of the speaker to the original spoken speech of the speaker. The transmitted personal speech codebook of the speaker also can use for identification, verification and recognition. The advantage of the method of the present invention is a reduction of the bandwidth required to transmit the speech signal. Another advantage of the method of the present invention is a reduction of the codebook memory by using only the voice of one speaker. Still another advantage of this method is a reduction of time of encoding, which is a result of reducing the codebook memory. Still another advantage of the method of the present invention is an absence of a complicated decoding program. Still another advantage of the present method of invention is an easier exchange of the information between a human and a computer. Still another advantage of the present method of invention is a reduction of quantization error by dynamic addition of the new voice information of the speaker to the personal speech codebook. Still another advantage of the method of the present invention is the capability to use any low-bit-rate encoders to create the personal speech codebook. Still another advantage of the method of present invention is increasing the automatic speaker identification, verification and recognition performance. Still another advantage of the present method of invention is that the speech-to-index coding program is not complicated and expansive for various users, such as, but not limited to, a telephone station, an Internet, an audio library, or a bank. use an inexpensive microcontroller to listen, for example, an audio lecture. Still another advantage of the method of the present invention is the ability to easily translate the speech from one language to another. The features and additional advantages of the present invention will be apparent from the following description.

### BRIEF DESCRIPTION OF THE DRAWINGS

FIG. 1 is a flowchart diagram illustrating a conversation between two speakers.

FIG. 2 is a flowchart diagram illustrating a creation, storage, transmission, recording and recovery of the audio lecture.

FIG. 3 is a flowchart diagram illustrating a conversation between a human and a computer.

### DETAILED DESCRIPTION OF PREFERRED EMBODIMENTS

The present invention provides the method for reduction of the bandwidth required to transmit the speech signal by transmission of the personal speech codebook and codebook indices of the spoken speech of the speaker. In the present invention the personal speech codebook of the speaker means an organized set of indices of reference patterns of all the necessary character information about a particular individual's voice. In the present invention speech-to-index and index-to-speech programs respectively encode and decode speech. The speech-to-index program: a) analyzes speech; b) compares data in the personal speech codebook to the spoken speech of the speaker, c) creates the personal speech codebook of the speaker; d) dynamically adds new codebook indices and unmatched data of the spoken speech to the personal speech codebook of the speaker, e) removes silent periods in a speech sequence. The transmitted indices of the spoken speech of the speaker are recovered to the original spoken speech by the index-to-speech program The personal speech codebook of the speaker is permanently stored. In the present invention the personal speech codebook of the speaker is permanently stored means, for example, permanently stored in a memory of the personal speech card, or in a personal memory of the telephone, or permanently stored in a personal memory of the telephone station, or permanently stored in a personal memory of the Internet, or permanently stored in a personal memory of the bank, or permanently stored in a personal memory of the PC computer.

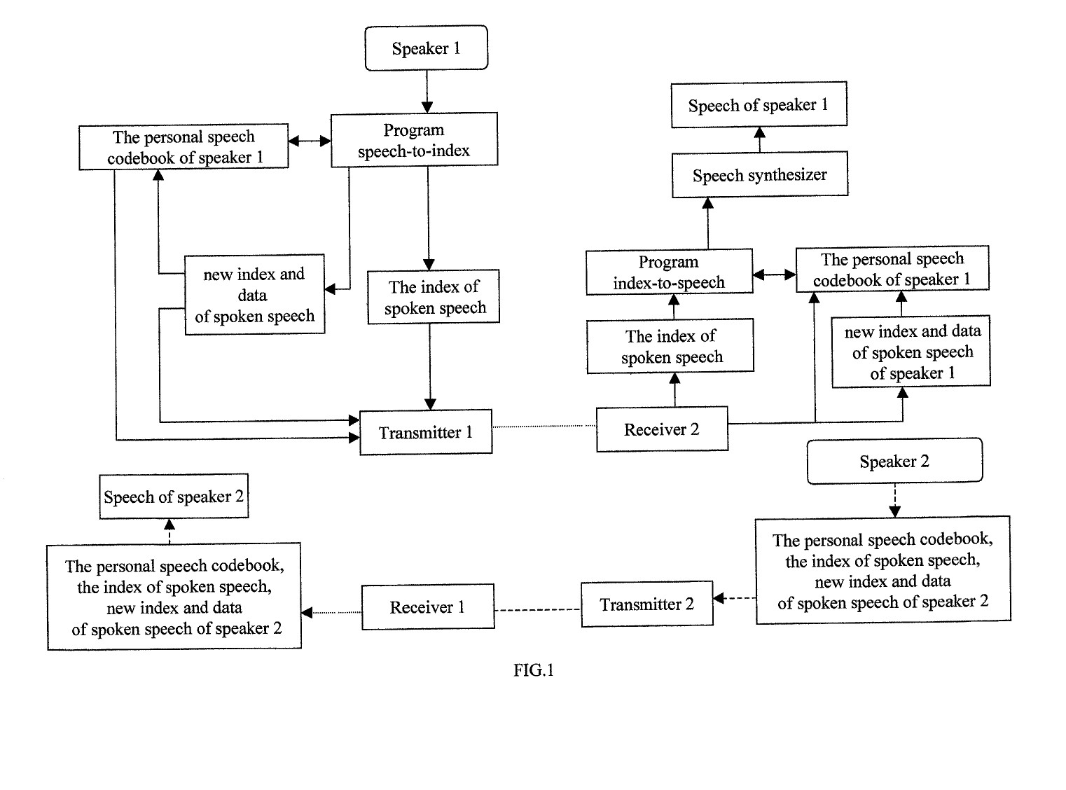

The example of using the transmitted personal speech codebook and indices of the spoken speech of the speaker is a conversation between two speakers illustrated in FIG. 1. The telephone station 1 sends the personal speech codebook of the speaker 1 to a station 2 and the telephone station 2 sends the personal speech codebook of the speaker 2 to the station 1 during a telephone connection. The speech-to-index programs of stations 1&2 encode the spoken speech of speakers respectively. The received codebook indices of the spoken speech of the speakers are recovered to the original spoken speech by the index-to-speech programs.

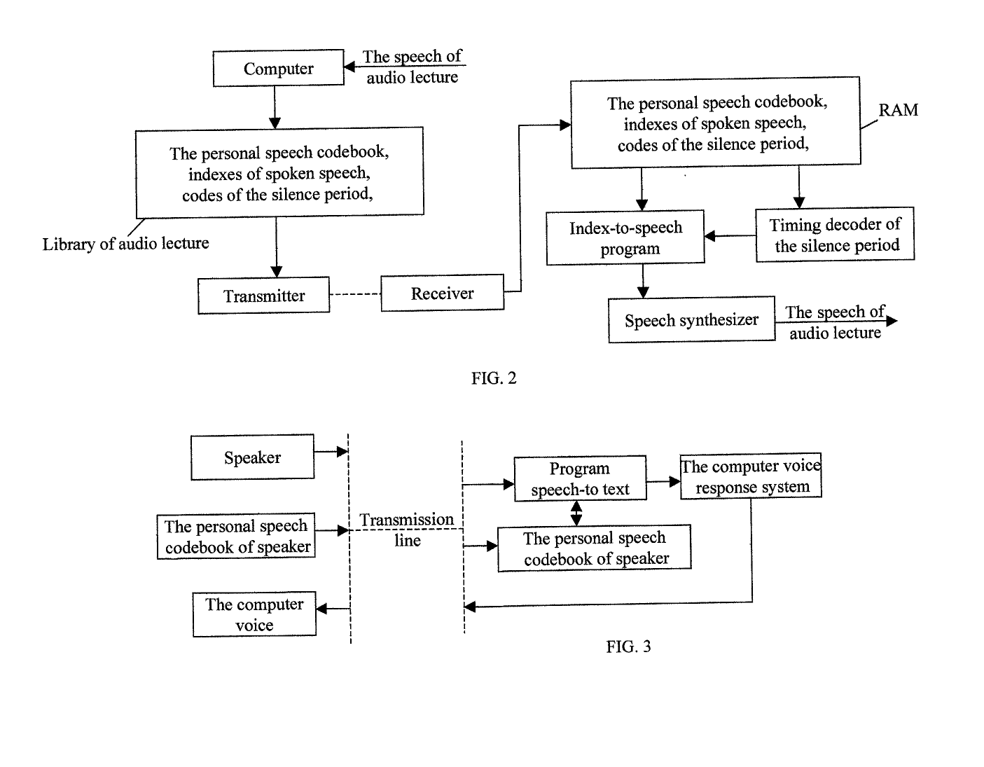

FIG. 3 illustrates another kind of information exchange, that between a human and a computer. The speaker sends the personal speech codebook information to the computer in the beginning of a connection. The speech-to-text program of the computer recognizes the transmitted spoken speech of the speaker by using the transmitted personal speech codebook. Thereafter the computer converts the transmitted spoken speech of the speaker to a text sequence, analyzes the text sequence, takes an answer from the computer memory and responds back to the speaker using the computer voice. The computer can also use the personal speech codebook information for identification or verification. Another example is a memory space reduction for speech of an audio lecture, see FIG. 2. The computer creates a personal speech codebook and indices of a spoken speech of the speaker by the speech-to-index program. The computer also measures and codes duration of the silence periods. The time-compressed speech is prepared and stored in the audio library, compact disks, or other medium. The personal speech codebook, indices of the spoken speech of the speaker and codes of the silence periods are transmitted. Then, the transmitted audio lecture is received and recovered to the original speech by the index-to-speech program with the timing decoder and the speech synthesizer.

Still in another example, the given method can also be used to encode and decode private conversations so that such conversations can take place on “open” transmission lines (e.g. telephone, internet, etc.) without third parties being able to de-scramble the information. The encoding/decoding can be accomplished by pre-pending/stripping random numbers to/from the sequence of indices from the personal speech codebook.

It has to be understood that the general idea of the present invention herein described and the implementation might be modified in different ways. For example, it can be used in the conversation between speakers, who use cellular phones. In another implementation, the transmitted personal speech codebook can contain a broadband quality speech (100-8000 Hz). Still in another example, the two speakers can speak in different languages. Each speaker transmits the personal speech codebook of the speaker to a computer. The computer recognized the speech of the speakers by index-to-text program, translates text from one language to another and converts text to speech by using the personal speech codebook of each speaker.

I claim:

1. A method of low-bit-rate transmission and storage of speech by transmission of the personal speech codebook and the index of the spoken speech of the speaker, comprising of the following steps:
a) creating in advance the said personal speech codebook of the speaker;
b) permanently storing the said personal speech codebook of the speaker;
c) transmitting the said personal speech codebook of the speaker;
d) receiving the said personal speech codebook of the speaker;
e) storing temporally the said received personal speech codebook of the speaker;
f) dynamically updating the said personal speech codebook of the speaker;
g) transmitting indices of the said spoken speech of the speaker;
h) receiving indices of the said spoken speech of the speaker;
i) decoding transmitted indices of the said spoken speech of the speaker to the original spoken speech of the speaker.

2. A method of transmission and storage of speech in accordance with claim 1, in which the transmitted personal speech codebook of the speaker is used for recognition.

3. A method of transmission and storage of speech in accordance with claim 1, in which the transmitted personal speech codebook of the speaker is used for verification.

4. A method of transmission and storage of speech in accordance with claim 1, in which the transmitted personal speech codebook of the speaker is used for identification.

5. A method of transmission and storage of speech in accordance with claim 1, in which the transmitted personal speech codebook and indices of spoken speech of the speaker is secured.
